(19) United States
(12) Patent Application Publication
(10) Pub. No.: US 2023/0360265 A1
(43) Pub. Date: Nov. 9, 2023

(54) INFORMATION PROCESSING APPARATUS, INFORMATION PROCESSING METHOD, AND PROGRAM

(71) Applicant: Sony Group Corporation, Tokyo (JP)

(72) Inventor: Tatsuki KASHITANI, Tokyo (JP)

(73) Assignee: Sony Group Corporation, Tokyo (JP)

(21) Appl. No.: 18/028,401

(22) PCT Filed: Sep. 14, 2021
(86) PCT No.: PCT/JP2021/033681

§ 371 Date: Mar. 24, 2023

(30) Foreign Application Priority Data
Nov. 16, 2020 (JP) 2020-189952

(51) Int. Cl. G06T 7/73

(52) U.S. Cl. CPC G06T 7/75

(57) ABSTRACT

[Object]

There is a desire to provide a technique that can reduce the uncertainty in a distance measurement result by a sensor, even in a case where the sensor moves.

[Solving Means]

Provided is an information processing apparatus that includes a candidate position calculation unit that obtains multiple candidate positions on the basis of first measurement data that is for a three-dimensional position and is obtained by a sensor, and a determination unit that, on the basis of the candidate positions and second measurement data that is for a three-dimensional position and is obtained by the sensor, determines any one of the candidate positions to be a determined position.

### TECHNICAL FIELD

The present disclosure relates to an information processing apparatus, an information processing method, and a program.

### BACKGROUND ART

In recent years, sensors (hereinafter, also referred to as “distance measurement sensors”) that can measure a distance (hereinafter, also referred to as “distance measurement”) to a subject (an object surface) are known. There can be distance measurement sensors for which, in terms of measurement principles, uncertainty arises in distance measurement results. As an example, assuming that an interval for a distance which cannot be distinguished by a distance measurement sensor (in other words, an interval for which uncertainty arises in a distance measurement result) is 10 [m], a distance measurement result for subjects at distances of 1 [m], 11 [m], 21 [m], . . . from the distance measurement sensor cannot be distinguished, and the distances to these subjects will all be measured as 1 [m].

An iToF (indirect Time-of-Flight) camera can be given as an example of a distance measurement sensor for which uncertainty arises in a distance measurement result. An iToF camera subjects emitted light to an intensity modulation, applies the intensity-modulated light, and uses the fact that the phase shift between applied light and reflected light is proportional to the distance to an object to perform distance measurement. Because the phase shift returns to zero every 360 degrees, the abovementioned uncertainty in a distance measurement result can arise. A distance interval that cannot be distinguished is determined in accordance with the modulation frequency of the emitted light. Various techniques for resolving the uncertainty in distance measurement results occurring in such a manner are known (for example, refer to NPL 1).

### CITATION LIST

### Non-Patent Literature

### [NPL 1]

Jongenelen, Adrian P P, et al. “Analysis of errors in tof range imaging with dual-frequency modulation.”, [online], IEEE transactions on instrumentation and measurement VOL. 60, NO. 5. (2011): 1861-1868. [search date: Oct. 2, 2020], internet <https://sprg.massey.ac.nz/pdfs/2011_tIM_1861.pdf>

### SUMMARY

### Technical Problem

However, there is a desire to provide a technique that can reduce the uncertainty in a distance measurement result by a sensor, even in a case where the sensor moves.

### Solution to Problem

By virtue of a certain aspect of the present disclosure, provided is an information processing apparatus that includes a candidate position calculation unit that obtains multiple candidate positions on the basis of first measurement data that is for a three-dimensional position and is obtained by a sensor, and a determination unit that, on the basis of the candidate positions and second measurement data that is for a three-dimensional position and is obtained by the sensor, determines any one of the candidate positions to be a determined position.

By virtue of another aspect of the present disclosure, provided is an information processing method that includes, by a processor, obtaining multiple candidate positions on the basis of first measurement data that is for a three-dimensional position and is obtained by a sensor, and determining, on the basis of the candidate positions and second measurement data that is for a three-dimensional position and is obtained by the sensor, that any one of the candidate positions to be a determined position.

In addition, by virtue of another aspect of the present disclosure, provided is a program for causing a computer to function as an information processing apparatus that includes a candidate position calculation unit configured to obtain multiple candidate positions on the basis of first measurement data that is for a three-dimensional position and is obtained by a sensor, and a determination unit configured to, on the basis of the candidate positions and second measurement data that is for a three-dimensional position and is obtained by the sensor, determine any one of the candidate positions to be a determined position.

### BRIEF DESCRIPTION OF DRAWINGS

FIG. 1 is a view that illustrates an example of a functional configuration of an information processing system according to a first embodiment of the present disclosure.

FIG. 2 is a view for giving a description regarding pose estimation using SLAM.

FIG. 3 is a view for giving a description regarding an outline of processing for P3P-RANSAC.

FIG. 4 is a view that illustrates an example of operation for an example of operation for P3P-RANSAC.

FIG. 5 is a view for describing a technique for reducing uncertainty in a distance measurement result, according to the same embodiment.

FIG. 6 is a view that illustrates an example of a 3D/2D list obtained after outlier rejection.

FIG. 7 is a view that illustrates an example of operation for resolving uncertainty in distance measurement, according to the same embodiment.

FIG. 8 is a view that illustrates an example of a functional configuration of an information processing system according to a second embodiment of the present disclosure.

FIG. 9 is a view for giving a description regarding a technique for determining a position, according to the same embodiment.

FIG. 10 is a view that illustrates an operation example for the information processing system according to the same embodiment.

FIG. 11 is a block diagram that illustrates an example of a hardware configuration for an information processing apparatus.

### DESCRIPTION OF EMBODIMENTS

With reference to the attached drawings, description is given in detail below regarding preferred embodiments of the present disclosure. Note that, in the present specification and drawings, the same reference symbol is applied to components having substantially the same functional configuration, and duplicate descriptions are omitted.

In addition, in the present specification and the drawings, multiple components having substantially the same or similar functional configuration may be distinguished by different numerals being added after the same reference signs. However, in a case where each of the multiple components having substantially the same or similar functional configuration is not particularly required to be distinguished, only the same reference sign is given. Furthermore, similar components belonging to different embodiments may be distinguished by different alphabets being added after the same reference signs. However, in a case where respective similar components are not particularly required to be distinguished, only the same reference sign is given.

Note that the description will be given in the following order.
0. Outline
1. First Embodiment
   1.1. Functional configuration example
   1.2. Pose estimation using SLAM
   1.3. Resolving uncertainty in distance measurement
   1.4. Operation for resolving uncertainty in distance measurement
2. Second Embodiment
   2.1. Functional configuration example
   2.2. Example of operation
3. Hardware configuration example
4. Summary

### 0. Outline

Firstly, description is given regarding an outline of embodiments according to the present disclosure. In recent years, distance measurement sensors are known. There can be distance measurement sensors for which, in terms of measurement principles, uncertainty arises in distance measurement results. Various techniques for resolving the uncertainty in distance measurement results are known (for example, refer to NPL 1). According to a corresponding technique, it is possible to widen the interval for distances that cannot be distinguished (interval at which uncertainty arises in a distance measurement result) by using not one but two modulation frequencies for performing intensity modulation.

However, according to a corresponding technique, it is necessary for an iToF camera to mutually overlap multiple images obtained on the basis of modulation frequencies that are mutually different. Accordingly, a need arises to maintain a state in which the iToF camera is not moving (a state in which the iToF camera is stationary). In a case where, hypothetically, an iToF camera is moving (in other words, in a case where at least one of the position and orientation of the iToF camera is changing), it is not possible to overlap multiple images with each other, and a situation in which a distance measurement result is unstable (a situation where motion blur occurs) can arise.

In embodiments according to the present disclosure, a case in which an iToF camera moves is assumed. Accordingly, when this technique is employed in a case where an iToF camera itself moves, the distance measurement accuracy will decrease. Accordingly, in embodiments according to the present disclosure, description is mainly given regarding a technique that enables uncertainty in a distance measurement result from an iToF camera to be reduced even in a case where the iToF camera moves.

In more detail, by virtue of embodiments according to the present disclosure, provided is an information processing apparatus that includes a candidate position calculation unit that obtains multiple candidate positions on the basis of first measurement data that is for a three-dimensional position and is obtained by an iToF camera, and a determination unit that, on the basis of the multiple candidate positions calculated by the candidate position calculation unit and the second measurement data that is for a three-dimensional position and is obtained by the iToF camera, determines any one of the multiple candidate positions calculated by the candidate position calculation unit to be a determined position.

By virtue of this configuration, it is possible to reduce uncertainty in a distance measurement result obtained from an iToF camera, even in a case in which the iToF camera moves. A first example of this configuration is described below as a “first embodiment,” and a second example of this configuration is described below as a “second embodiment.” Note that an iToF camera is an example of a sensor that measures a distance to a subject (an object surface). Accordingly, as also describe below, another sensor that can measure the distance to a subject may be used in place of an iToF camera.

Description has been given above regarding an outline of embodiments of the present invention.

### 1. First Embodiment

Next, description is given regarding a first embodiment of the present disclosure.

(1.1. Functional Configuration Example)

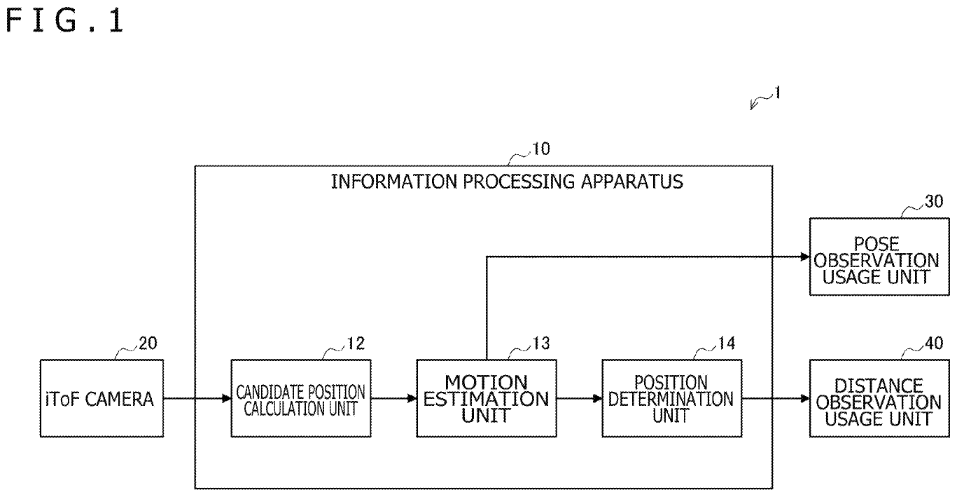

Firstly, description is given regarding an example of a functional configuration of an information processing system according to the first embodiment of the present disclosure. FIG. 1 is a view that illustrates an example of a functional configuration of the information processing system according to the first embodiment of the present disclosure. As illustrated in FIG. 1, an information processing system 1 according to a first embodiment of the present disclosure includes an information processing apparatus 10, an iToF camera 20, a pose observation usage unit 30, and a distance measurement observation usage unit 40.

(iToF Camera 20)

The iToF camera 20 is a distance measurement sensor that can perform measurement (distance measurement) of the distance to a subject (a surface of an object) to thereby obtain a distance measurement result. The iToF camera 20 subjects emitted light to an intensity modulation, applies the intensity-modulated light, and, on the basis of the phase shift between applied light and light reflected by an object surface, uses the fact that the phase shift is proportional to the distance to the object, to measure the distance to a subject (a three-dimensional position on the object surface). However, because the phase shift repeats every 360 degrees, the abovementioned uncertainty in a distance measurement result can arise, as described above. A distance interval that cannot be distinguished is determined in accordance with the modulation frequency of the emitted light.

The iToF camera 20 outputs a distance measurement result to the information processing apparatus 10. In more detail, a distance measurement result outputted from the iToF camera 20 to the information processing apparatus 10 can be a two-dimensional image in which, for each pixel, a distance measurement result with respect to a subject is arranged. As described above, the iToF camera 20 is an example of a sensor that measures a distance to a subject. Accordingly, another sensor (for which uncertainty can arise in a distance measurement result) that can measure the distance to a subject may be used in place of the iToF camera 20. In addition, the iToF camera 20 outputs, to the information processing apparatus 10, a luminance of reflected light as an image (a luminance image). As also described below, a luminance image can be used in order to obtain a two-dimensional position, which is an observation position for a feature point. Note that the iToF camera 20 may be incorporated in the information processing apparatus 10.

(Information Processing Apparatus 10)

The information processing apparatus 10 estimates the position and orientation of the iToF camera 20 on the basis of a distance measurement result outputted by the iToF camera 20. The position and orientation of the iToF camera 20 can correspond to a pose for the iToF camera 20. The information processing apparatus 10 outputs the estimated position and orientation (pose) of the iToF camera 20 to the pose observation usage unit 30. Further, uncertainty for a distance measurement result outputted by the iToF camera 20 is reduced. The information processing apparatus 10 outputs a distance measurement result for which uncertainty has been reduced to the distance measurement observation usage unit 40.

The information processing apparatus 10 includes a candidate position calculation unit 12, a motion estimation unit 13 (a position and orientation estimation unit), and a position determination unit 14. The motion estimation unit 13 and the position determination unit 14 can include the determination unit described above. Note that description is given later regarding detailed functions for each of the candidate position calculation unit 12, the motion estimation unit 13, and the position determination unit 14.

The information processing apparatus 10, for example, may include one or more CPUs (Central Processing Unit) and the like. In a case where the information processing apparatus 10 includes a processor such as a CPU, this processor may include an electronic circuit. For the information processing apparatus 10, it is possible to use this processor to (realize execution of a program for causing a computer to function as the information processing apparatus 10.

In addition, the information processing apparatus 10 includes a memory which is not illustrated. The unillustrated memory is a recording medium that stores a program that is executed by the information processing apparatus 10, and stores data necessary for execution of this program. In addition, the unillustrated memory temporarily stores data for calculation by the information processing apparatus 10. The unillustrated memory includes a magnetic storage device, a semiconductor storage device, an optical storage device, a magneto-optical storage device, or the like.

(Pose Observation Usage Unit 30)

The pose observation usage unit 30 uses a position and orientation (a pose) which are for the iToF camera 20 and are outputted by the information processing apparatus 10. In more detail, the pose observation usage unit 30 uses a position and orientation (a pose) which are for the iToF camera 20 and are estimated by the motion estimation unit 13 in the information processing apparatus 10. Note that the pose observation usage unit 30 may be incorporated in the information processing apparatus 10.

(Distance Measurement Observation Usage Unit 40)

The distance measurement observation usage unit 40 uses a distance measurement result for which uncertainty has been reduced and which is outputted by the information processing apparatus 10. In more detail, distance measurement observation usage unit 40 uses a distance measurement result for which uncertainty has been reduced and which is outputted by the position determination unit 14 in the information processing apparatus 10. Note that the distance measurement observation usage unit 40 may be incorporated in the information processing apparatus 10.

Description has been given above regarding an example of a functional configuration of the information processing system 1 according to the first embodiment of the present disclosure.

(1.2. Pose Estimation Using SLAM)

The information processing apparatus 10 according to the first embodiment of the present disclosure reduces uncertainty in a distance measurement result on the basis of a combination of a distance measurement result obtained using the iToF camera 20 and a technique referred to as SLAM (Simultaneous Localization And Mapping). SLAM performs, in parallel, estimation of the position and orientation of a camera in a global coordinate system associated with real space and creation of an environment map for the surroundings of the camera.

In more detail, SLAM sequentially estimates a three-dimensional shape for a subject on the basis of an image obtained by the camera. Together with this, on the basis of the image obtained by the camera, SLAM estimates, as self-position information (a translational component) and self-orientation information (a rotational component), information indicating relative change in the position information and orientation of the camera (motion by the camera). SLAM associates the three-dimensional shape, self-position information, and self-orientation information with each other, whereby it is possible to perform creation of a surrounding environment map and estimation of the position and orientation (pose) of the camera in this environment, in parallel.

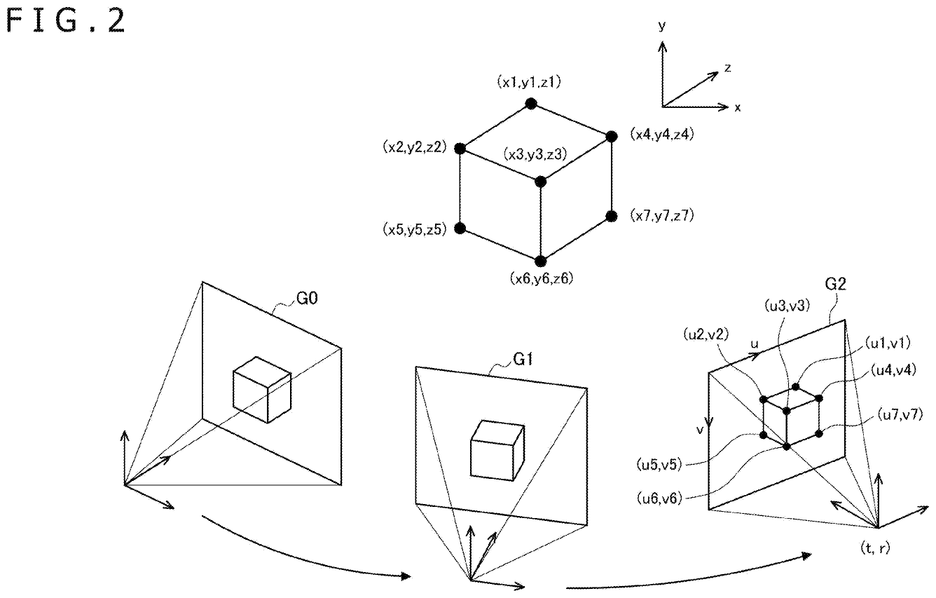

With reference to FIG. 2 through FIG. 4, description is given below regarding an outline of pose estimation using SLAM.

FIG. 2 is a view for giving a description regarding pose estimation using SLAM. Referring to FIG. 2, an object is present in real space, and three-dimensional positions (x1, y1, z1) through (x7, y7, z7) for multiple feature points for the object are illustrated. (x1, y1, z1) through (x7, y7, z7) are three-dimensional positions in a global coordinate system and do not change due to motion by a camera.

Further, referring to FIG. 2, two-dimensional images G0 through G2 obtained by the camera and by following a chronological order are illustrated. Respective feature points appear in each of the two-dimensional images G0 through G2. Note that the number of feature points in the example illustrated in FIG. 2 is seven, but the number of feature points appearing in each of the two-dimensional images G0 through G2 is not limited. In the two-dimensional image G2, observation positions at which respective feature points appear are illustrated as two-dimensional positions (u1, v1) through (u7, v7). The two-dimensional positions (u1, v1) through (u7, v7), which are observation positions, can change due to motion by the camera.

The three-dimensional position (x1, y1, z1) and the two-dimensional position (u1, v1) are positions for the same feature point, and correspond to each other. Similarly, the three-dimensional position (x2, y2, z2) and the two-dimensional position (u2, v2) correspond to each other, . . . , and the three-dimensional position (x7, y7, z7) and the two-dimensional position (u7, v7) correspond to each other. On the basis of a 3D/2D list in which such three-dimensional positions and two-dimensional positions are associated with each other, SLAM estimates, as the position and orientation (pose) of the camera, motion (a translational component t and a rotational component r) for the camera from a certain reference time to a time when the two-dimensional image G2 is obtained.

Note that a problem of estimating the position and orientation of a camera on the basis of three-dimensional positions for n points in a global coordinate system and two-dimensional positions in an image in which these points have been observed is known as a PnP problem (Perspective-n-Points Problem).

A group of an associated three-dimensional position and a two-dimensional position in a 3D/2D list is also referred to as an “entry” below. Here, a 3D/2D list can include an entry (hereinafter, also referred to as an “inlier”) having a correct association between a three-dimensional position and a two-dimensional position, but can also include an entry (hereinafter, also known as an “outlier”) having an erroneous association between a three-dimensional position and a two-dimensional position. In SLAM, a process for rejecting outliers from a 3D/2D list can also be executed.

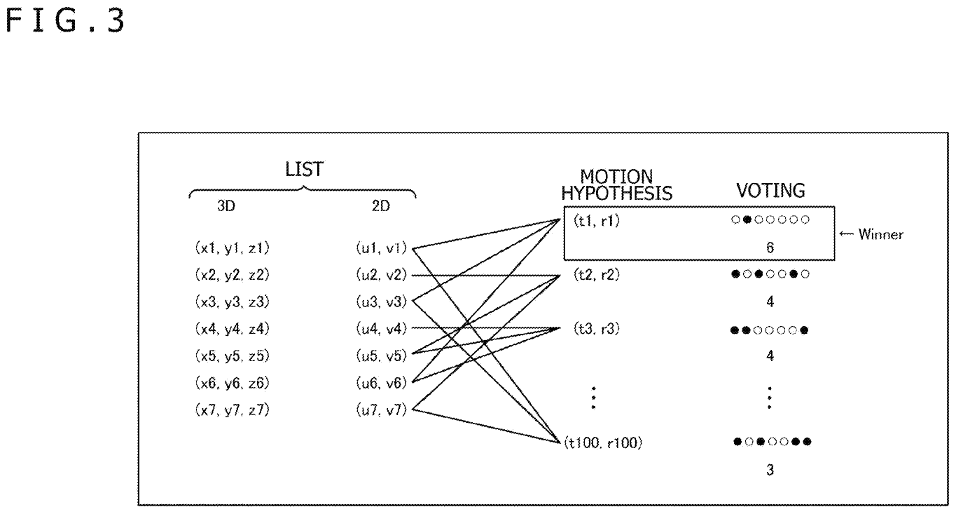

P3P-RANSAC (Perspective 3 Point RANdom SAmple Consensus) is known as an example of an algorithm for rejecting outliers from a 3D/2D list. With reference to FIG. 3, description is given regarding an outline of processing for P3P-RANSAC.

### (Outline of Processing for P3P-RANSAC)

FIG. 3 is a view for giving a description regarding an outline of processing for P3P-RANSAC. With reference to FIG. 3, a 3D/2D list is described. In a P3P-RANSAC process, a corresponding 3D/2D list is obtained. A selection process for randomly selecting three entries from the 3D/2D list and a generation process for generating a motion hypothesis (translational component t and rotational component r) on the basis of three-dimensional positions included in the three entries are executed. As a result, the motion hypothesis is generated.

Described with reference to FIG. 3, motion hypotheses and three-dimensional positions used for the generation thereof are joined by lines. As an example, illustration is given as an example in which a motion hypothesis (t1, r1) is generated on the basis of the three-dimensional position (x1, y1, z1) and the two-dimensional position (u1, v1), the three-dimensional position (x3, y3, z3) and the two-dimensional position (u3, v3), and the three-dimensional position (x6, y6, z6) and the two-dimensional position (u6, v6). Next, a projection position which is for the three-dimensional position (x1, y1, z1) included in the 3D/2D list and is with respect to a two-dimensional image corresponding to the motion hypothesis (t1, r1) is calculated, the distance between each projection position and the two-dimensional position (u1, v1) (observation position) corresponding to the three-dimensional position (x1, y1, z1) is calculated, a vote indicating ∘ (a predetermined vote) is cast for the motion hypothesis (t1, r1) in a case where the distance is less than a threshold, and a vote indicating ● is cast for the motion hypothesis (t1, r1) in a case where the distance is greater than or equal to the threshold.

Such voting is executed in relation to all entries included in the 3D/2D list. As an example, illustration is given as an example in which, with respect to the motion hypothesis (t1, r1), a vote indicating ∘ is cast from the entry including the three-dimensional position (x1, y1, z1) and the two-dimensional position (u1, v1), a vote indicating ● is cast from the entry including the three-dimensional position (x2, y2, z2) and the two-dimensional position (u2, v2), . . . , and a vote indicating ∘ is cast from the entry including the three-dimensional position (x7, y7, z7) and the two-dimensional position (u7, v7). Similarly, an example in which motion hypotheses (t2, r2) through (t100, r100) are also generated is illustrated. Here, an upper-limit number of generated motion hypotheses is decided to be 100.

Next, from among the motion hypotheses (t1, r1) through (t100, r100), the motion hypothesis having the greatest number of votes indicating ∘ (number of votes achieved) is selected. In the example illustrated in FIG. 3, the number of votes indicating ∘ cast with respect to the motion hypothesis (t1, r1) is 6, and the motion hypothesis (t1, r1) is the motion hypothesis having the greatest number of votes achieved. Accordingly, the motion hypothesis (t1, r1) is selected (indicated as “Winner” in FIG. 3).

The entry that has cast the vote indicating ● with respect to the motion hypothesis (t1, r1) selected in such a manner is determined to be an outlier. As an example, an entry determined to be an outlier is rejected from the 3D/2D list. In contrast, entries that cast a vote indicating ∘ with respect to the motion hypothesis (t1, r1) selected in such a manner are determined to be inliers, and are kept in the 3D/2D list.

In the example illustrated in FIG. 3, an entry that has cast a vote indicating ● with respect to the selected motion hypothesis (t1, r1) is only the entry including the three-dimensional position (x2, y2, z2) and the two-dimensional position (u2, v2). Accordingly, only this entry is set as an outlier and rejected from the 3D/2D list, and other entries are kept as inliers in the 3D/2D list.

As an example, the selected motion hypothesis (t1, r1) is outputted as the position and orientation (pose) of the camera 20. Further, the 3D/2D list from which the outlier has been rejected and the inliers have been kept is outputted as information in which a three-dimensional position for a respective feature point and an observation position in a two-dimensional image are associated with each other.

### (P3P-RANSAC Operation Example)

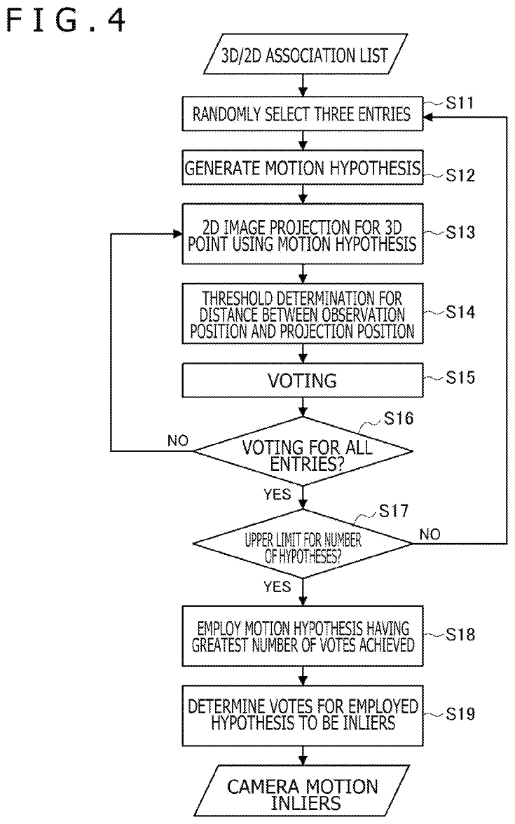

FIG. 4 is a view that illustrates an example of operation for an example of operation for P3P-RANSAC. As illustrated in FIG. 4, a 3D/2D list is obtained in P3P-RANSAC. The 3D/2D list includes a three-dimensional position (x1, y1, z1) which is a target for resolving uncertainty. Next, three entries are randomly selected from the 3D/2D list (S11). A motion hypothesis is generated on the basis of the three selected entries (S12). A motion hypothesis (t1, r1) is generated first.

Next, a projection position that is for a three-dimensional position included in the 3D/2D list and is with respect to the two-dimensional image corresponding to the motion hypothesis is calculated (313). Firstly, a projection position for the three-dimensional position (x1, y1, z1), which is included in the 3D/2D list, with respect to the two-dimensional image corresponding to the motion hypothesis (t1, r1) is calculated. Next, the distance between the two-dimensional position (observation position) corresponding to the three-dimensional position and the projection position is calculated, a vote indicating ∘ (a predetermined vote) is performed for the motion hypothesis in a case where the distance is less than a threshold, and a vote indicating ● is performed for the motion hypothesis in a case where the distance is greater than or equal to the threshold (S14 and S15).

Firstly, the distance between the two-dimensional position (u1, v1) (observation position) corresponding to the three-dimensional position (x1, y1, z1) and the projection position is calculated, it is determined that this distance is less than the threshold, and a vote indicating ∘ (a predetermined vote) is cast for the motion hypothesis (t1, r1). In a case where there is an entry for which voting has not ended (“NO” in S16), the operation is transitioned to S13. In contrast, in a case where voting has ended for all entries (“YES” in S16), the operation is transitioned to S17. In a case where voting from all entries included in the 3D/2D list has ended with respect to the motion hypothesis (t1, r1), the operation is transitioned to S17.

In a case where motion hypotheses for which voting has ended do not reach the upper limit (“NO” in S17), the operation is transitioned to S11. In contrast, in a case where voting has ended for the upper limit for motion hypotheses (“NO” in S17), the operation is transitioned to S18. Specifically, in a case where voting for the motion hypotheses (t1, r1) through (t100, r100) has ended, the operation is transitioned to S18.

Next, from among the motion hypotheses (t1, r1) through (t100, r100), the motion hypothesis having the greatest number of votes indicating ∘ (number of votes achieved) is employed (S18). In the example illustrated in FIG. 3, the motion hypothesis (t1, r1) has the greatest number of votes achieved, and thus the motion hypothesis (t1, r1) is employed. As an example, the selected motion hypothesis (t1, r1) is outputted to the pose observation usage unit 30 as the position and orientation (pose) of the iToF camera 20.

The entry that has cast the vote indicating ● with respect to the motion hypothesis (t1, r1) selected in such a manner is determined to be an outlier. As an example, an entry determined to be an outlier is rejected from the 3D/2D list. In contrast, entries that cast a vote indicating ∘ with respect to the motion hypothesis (t1, r1) selected in such a manner are determined to be inliers, and are kept in the 3D/2D list (S19).

With reference to FIG. 2 through FIG. 4, description has been given above regarding an outline of pose estimation using SLAM.

(1.3. Resolving Uncertainty in Distance Measurement)

As described above, the information processing apparatus 10 according to the first embodiment of the present disclosure reduces uncertainty in a distance measurement result on the basis of a combination of a distance measurement result obtained using the iToF camera 20 and a technique referred to as SLAM. In more detail, the information processing apparatus 10 according to the first embodiment of the present disclosure reduces uncertainty in a distance measurement result obtained by the iToF camera 20 in the P3P-RANSAC process described above. Description is given below regarding a technique for reducing uncertainty in a distance measurement result.

In the first embodiment of the present disclosure, the iToF camera 20 is used as a camera. At this time, distance measurement results (measurement data) for each feature point obtained by the iToF camera 20 can be used as three-dimensional positions (x1, y1, z1) through (x7, y7, z7) for respective feature points. In contrast, two-dimensional positions (u1, v1) through (u7, v7), which are observation positions for respective feature points, can be obtained from a luminance image outputted from the iToF camera 20. A 3D/2D list, in which three-dimensional positions and two-dimensional positions obtained in such a manner are associated with each other, is created.

As an example, in the first embodiment of the present disclosure, consideration is given to resolving uncertainty for the three-dimensional position (x1, y1, z1). The three-dimensional position (x1, y1, z1) can correspond to an example of first measurement data. At this time, the candidate position calculation unit 12 obtains a modulation frequency for irradiation light from the iToF camera 20. The candidate position calculation unit 12 can calculate multiple candidate positions on the basis of the modulation frequency for the irradiation light and the three-dimensional position (x1, y1, z1).

In more detail, the candidate position calculation unit 12 divides the speed of light by the modulation frequency for the irradiation light to thereby calculate a distance interval d1 (in other words, the interval at which uncertainty arises for a distance measurement result) that cannot be distinguished by the iToF camera 20. The candidate position calculation unit 12 adds a unit vector for (x1, y1, z1)×the interval d1×n (n is an integer that is greater than or equal to 1) to the three-dimensional position (x1, y1, z1) to thereby calculate candidate positions other than (x1, y1, z1).

Here, a case in which n=1, 2 is assumed. In other words, a case in which the candidate position calculation unit 12 adds the unit vector for (x1, y1, z1)×the interval d1×1 to the three-dimensional position (x1, y1, z1) to thereby calculate a candidate position (x1′, y1′, z1′), and adds the unit vector for (x1, y1, z1)×the interval d1×2 to the three-dimensional position (x1, y1, z1) to thereby calculate a candidate position (x1″, y1″, z″) is assumed.

As a result, because the candidate position (x1′, y1′, z1′) and the candidate position (x1″, y1″, z1″) are calculated in addition to the candidate position (x1, y1, z1), three candidate positions are calculated. However, the number of candidate positions calculated by the candidate position calculation unit 12 is not limited as long as the number is plural. The motion estimation unit 13 adds, to a 3D/2D list, entries in which these candidate positions (x1, y1, z1), (x1′, y1′, z1′), and (x1″, y1″, z1″) calculated by the candidate position calculation unit 12 are respectively associated with a two-dimensional position (u1, v1) which is an observation position.

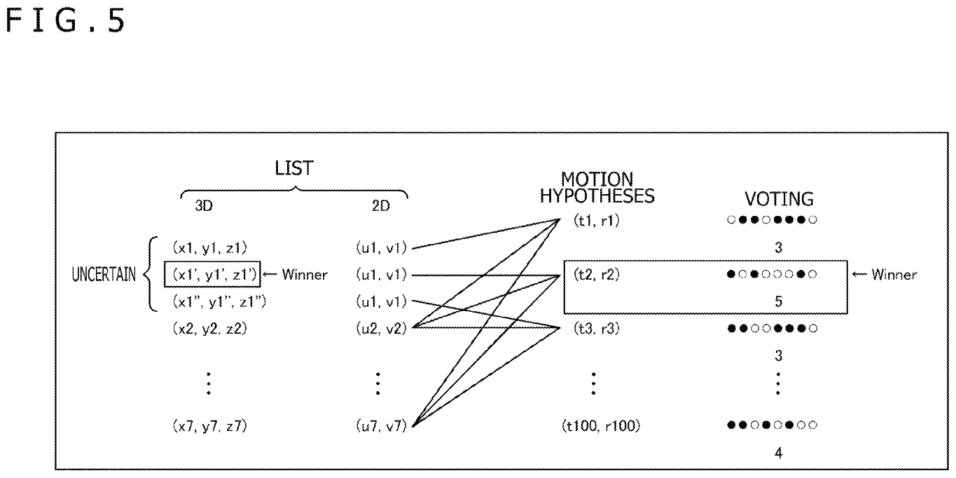

FIG. 5 is a view for describing a technique for reducing uncertainty in a distance measurement result, according to the first embodiment of the present disclosure. Referring to FIG. 5, entries, in which candidate positions (x1, y1, z1), (x1′, y1′, z1′), and (x1″, y1″, z1″) are respectively associated with a two-dimensional position (u1, v1) which is an observation position, are added to a 3D/2D list. The 3D/2D list also includes other entries. The measurement positions (x2, y2, z2) through (x7, y7, z7) can correspond to examples of second measurement data. Note that second measurement data is only required to include one or multiple measurement positions (three-dimensional positions).

In embodiments according to the present disclosure, on the basis of the candidate positions (x1, y1, z1), (x1′, y1′, z1′), and (x1″, y1″, z1″) and the measurement positions (x2, y2, z2) through (x7, y7, z7), the motion estimation unit 13 estimates the position and orientation (pose) of the iToF camera 20 to thereby obtain an estimation result (position and orientation estimation information). On the basis of the estimation result, the position determination unit 14 determines any one of the candidate positions (x1, y1, z1), (x1′, y1′, z1′), and (x1″, y1″, z1″) to be a determined position. As a result, uncertainty in the three-dimensional position (x1, y1, z1) can be resolved.

The motion estimation unit 13 performs a selection process for randomly selecting a predetermined number of entries from the 3D/2D list. The predetermined number is not limited as long as the predetermined number is three or more, but a case in which the predetermined number is three is assumed below. As an example, the motion estimation unit 13 may obtain an estimation result by estimating the position and orientation (pose) of the iToF camera 20 on the basis of three-dimensional positions included in the selected three entries.

However, in the first embodiment of the present disclosure, similarly to P3P-RANSAC processing, a case in which the motion estimation unit 13 executes a selection process for selecting three entries and a generation process for generating a motion hypothesis (position and orientation generation information) on the basis of three-dimensional positions included in the three selected entries multiple times is mainly assumed. As a result, multiple motion hypotheses is generated. The motion estimation unit 13 selects one motion hypothesis from multiple motion hypotheses as an estimation result.

At this time, it is desirable for the motion estimation unit 13 not to select, as three entries in each of the selection processes, two or more of the three entries that include the candidate positions (x1, y1, z1), (x1′, y1′, z1′), and (x1″, y1″, z1″). As a result, because there is at most one candidate position used to generate one motion hypothesis, it becomes easier for one candidate position from among the candidate positions (x1, y1, z1), (x1′, y1′, z1′), and (x1″, y1″, z1″) to be determined, as also described below.

In the example illustrated in FIG. 5, the candidate position (x1, y1, z1) is used to generate the motion hypothesis (t1, r1), the candidate position (x1′, y1′, z1′) is used to generate the motion hypothesis (t2, r2), and the candidate position (x1″, y1″, z1″) is used to generate the motion hypothesis (t3, r3). In other words, the candidate positions (x1, y1, z1), (x1′, y1′, z1′), and (x1″, y1″, z1″) are used to generate respectively different motion hypotheses.

An upper-limit number of motion hypotheses generated by the motion estimation unit 13 is not limited. Here, a case in which the upper-limit number of motion hypotheses generated by the motion estimation unit 13 is 100 is assumed. Referring to FIG. 5, an example in which motion hypotheses (t1, r1) through (t100, r100) are generated is illustrated. For each motion hypothesis, the motion estimation unit 13 calculates, for each candidate position and measurement position, the distance between an observation position, which appears in a two-dimensional image, and a projection position that is with respect to the two-dimensional image corresponding to the motion hypothesis. The motion estimation unit 13 selects a motion hypothesis on the basis of the distance between the observation position and the projection position for each motion hypothesis.

In more detail, the motion estimation unit 13 calculates a projection position which is for the three-dimensional position (x1, y1, z1) included in the 3D/2D list and is with respect to the two-dimensional image corresponding to the motion hypothesis (t1, r1). The motion estimation unit 13 calculates the distance between the calculated projection position and the two-dimensional position (u1, v1) (an observation position) corresponding to the three-dimensional position (x1, y1, z1). The motion estimation unit 13 casts a vote indicating ∘ (a predetermined vote) for the motion hypothesis (t1, r1) in a case where the distance is less than a threshold, and casts a vote indicating ● for motion hypothesis (t1, r1) in a case where the distance is greater than or equal to the threshold. Such voting is executed in relation to all entries included in the 3D/2D list.

Next, from among the motion hypotheses (t1, r1) through (t100, r100), the motion estimation unit 13 selects the motion hypothesis having the greatest number of votes indicating ∘ (number of votes achieved). In the example illustrated in FIG. 5, the number of votes indicating ∘ cast with respect to the motion hypothesis (t2, r2) is 5, and the motion hypothesis (t2, r2) is the motion hypothesis having the greatest number of votes achieved. Accordingly, the motion hypothesis (t2, r2) is selected (indicated as “Winner” in FIG. 5).

The motion estimation unit 13 determines an entry that has cast a vote indicating ● with respect to the motion hypothesis (t2, r2) selected in such a manner to be an outlier, and rejects the entry that has cast a vote indicating ● from the 3D/2D list. In contrast, the motion estimation unit 13 determines an entry that has cast a vote indicating ∘ with respect to the motion hypothesis (t2, r2) selected in such a manner to be an inlier, and keeps the entry that has cast a vote indicating ∘ in the 3D/2D list. Further, the motion estimation unit 13 outputs the position and orientation (pose) of the iToF camera 20 to the pose observation usage unit 30. At this time, the motion estimation unit 13 may output the selected motion hypothesis (t2, r2) itself to the pose observation usage unit 30. Alternatively, the motion estimation unit 13 may output, to the pose observation usage unit 30, a pose obtained by re-estimating a motion hypothesis on the basis of entries determined to be inliers. As a result, it is possible for a more accurate pose to be outputted to the pose observation usage unit 30.

In the example illustrated in FIG. 5, entries that cast a vote indicating ● with respect to the selected motion hypothesis (t2, r2) are the entry including the three-dimensional position (x1, y1, z1) and the two-dimensional position (u1, v1), the entry including the three-dimensional position (x1″, y1″, z1″) and the two-dimensional position (u1, v1), and the entry including the three-dimensional position (x6, y6, z6) and the two-dimensional position (u6, v6). Accordingly, the motion estimation unit 13 sets these entries as outliers and rejects these entries from the 3D/2D list, and keeps other entries as inliers in the 3D/2D list. Note that the motion estimation unit 13 do not need to immediately reject entries determined to be outliers from the 3D/2D list. For example, the motion estimation unit 13 may reject, from the 3D/2D list, an entry for which the number of times that the entry has been determined to be an outlier has reached a threshold.

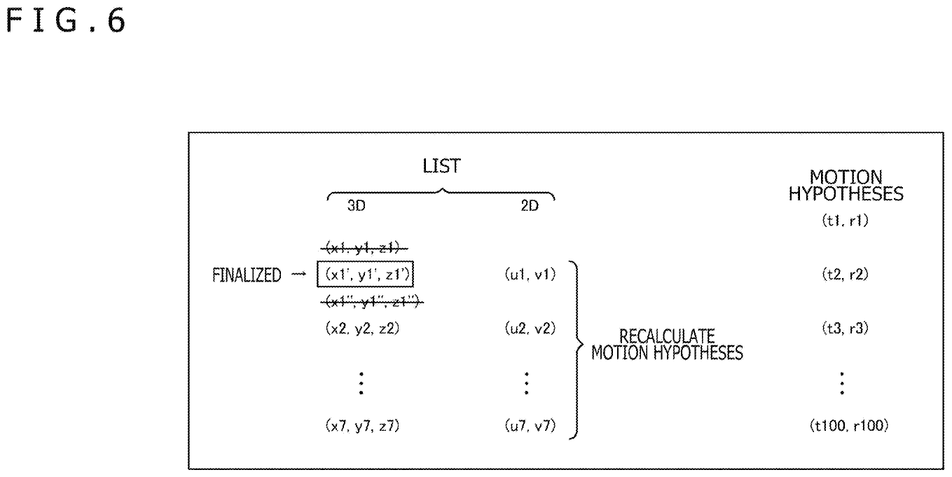

FIG. 6 is a view that illustrates an example of the 3D/2D list obtained after outlier rejection. Referring to FIG. 6, the entry including the three-dimensional position (x1, y1, z1) and the two-dimensional position (u1, v1), the entry including the three-dimensional position (x1″, y1″, z1″) and the two-dimensional position (u1, v1), and the entry including the three-dimensional position (x6, y6, z6) and the two-dimensional position (u6, v6) have been rejected from the 3D/2D list obtained after outlier rejection. In contrast, the determined position (x1′, y1′, z1′) is kept, as an inlier, in the 3D/2D list obtained after outlier rejection.

Note that, in the example illustrated in FIG. 5, from among the candidate positions (x1, y1, z1), (x1′, y1′, z1′), and (x1″, y1″, z1″), only the entry that includes the candidate position (x1′, y1′, z1′) is determined to be an inlier. Accordingly, the position determination unit 14 is only required to determine that the candidate position (x1′, y1′, z1′) included in the entry determined to be an inlier (in other words, the entry that voted ∘ for the selected motion hypothesis) is a determined position. As a result, uncertainty in the three-dimensional position (x1, y1, z1) obtained by the iToF camera 20 can be resolved. However, a technique for determining one candidate position from the candidate positions (x1, y1, z1), (x1′, y1′, z1′), and (x1″, y1″, 1i″) is not limited to this example.

In other words, from among the candidate positions (x1, y1, z1), (x1′, y1′, z1′), and (x1″, y1″, z1″), the position determination unit 14 is only required to determine that a candidate position that satisfies a predetermined condition (hereinafter, also referred to as a “determination condition”) is a determined position. At this point, the determination condition may include a first condition of being included in the three positions used to generate the selected motion hypothesis. Alternatively, the determination condition may include a second condition of having cast a vote indicating ∘ for the selected motion hypothesis. Alternatively, the determination condition may include a third condition of having a shortest distance between an observation position and a projection position in the selected motion hypothesis.

Alternatively, the determination condition may be a logical conjunction of any two or more conditions from among the first condition through the third condition, or may be a logical disjunction of any two or more of the first condition through the third condition.

For example, the position determination unit 14 may determine whether one candidate position satisfying the first condition can be narrowed down from three candidate positions and, in a case where there is no candidate position satisfying the first condition, determine whether one candidate position satisfying the second condition can be narrowed down from the three candidate positions. Note that, as described above, if two or more candidate positions are not used to generate one motion hypothesis, there ceases to be a possibility of being multiple candidate positions that satisfies the first condition.

Further, in a case where there is not even one candidate position which satisfies the second condition, the position determination unit 14 may determine, from the three candidate positions, a candidate position satisfying the third condition to be a determined position. Alternatively, in a case where there is multiple candidate positions satisfying the second condition, the position determination unit 14 may determine, from the multiple candidate positions satisfying the second condition, a candidate position satisfying the third condition to be a determined position.

The position determination unit 14 outputs a distance measurement result for which uncertainty has been reduced to the distance measurement observation usage unit 40. In more detail, the position determination unit 14 finalizes a distance measurement result for the projection position that corresponds to the three-dimensional position (x1, y1, z1) set as a target for resolving uncertainty and is from a two-dimensional image obtained by the iToF camera 20 to a distance corresponding to the determined position (x1′, y1′, z1′), and then outputs a finalized two-dimensional image to the distance measurement observation usage unit 40. Note that the distance corresponding to the determined position (x1′, y1′, z1′) is a result of adding the interval d1×1 to a length for (x1, y1, z1).

Note that the determined position (x1′, y1′, z1′), which is selected from multiple candidates as described above, may be used to re-estimate the position and orientation (pose) of the iToF camera 20 by the motion estimation unit 13. By using the three-dimensional position (x1′, y1′, z1′) for which uncertainty has been resolved to re-estimate the pose of the iToF camera 20, pose estimation for the iToF camera 20 can be performed with higher accuracy.

To give a description in further detail with reference to the 3D/2D list, which is illustrated in FIG. 6, after outlier rejection, (x1′, y1′, z1′) kept in the 3D/2D list may be used again when re-estimating the pose of the iToF camera 20. Meanwhile, the two-dimensional position (u1, v1) corresponding to (x1′, y1′, z1′) may be updated on the basis of a two-dimensional image which is obtained by the iToF camera 20 again. Similarly, (x2, y2, z2) through (x5, y5, z5) and (x7, y7, z7) which are kept in the 3D/2D list may be used again when re-estimating the pose of the iToF camera 20. Meanwhile, the two-dimensional positions (u2, v2) through (u5, v5) and (u7, v7) that respectively correspond thereto may be updated on the basis of a two-dimensional image which is obtained by the iToF camera 20 again.

In place of the entry rejected as an outlier in which (x6, y6, z6) and (u6, v6) are associated with each other, a three-dimensional position and a two-dimensional position that have been obtained again on the basis of two-dimensional image obtained by the iToF camera 20 again may be added to the 3D/2D list. The pose of the iToF camera 20 may be re-estimated on the basis of a 3D/2D list that has been updated in such a manner. Pose re-estimation based on the updated 3D/2D list is only required to be performed similarly to the pose estimation described above.

(1.4. Operation for Resolving Uncertainty in Distance Measurement)

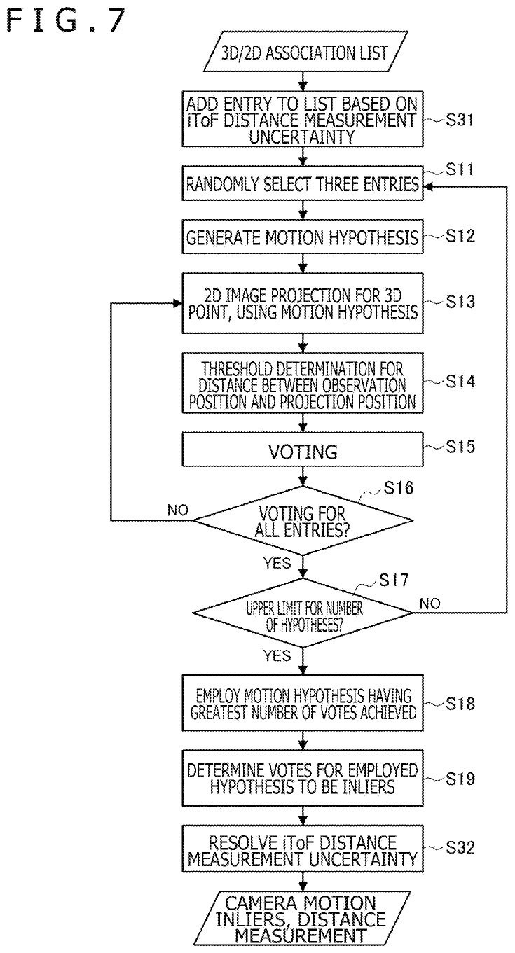

FIG. 7 is a view that illustrates an example of operation for resolving uncertainty in distance measurement, according to the first embodiment of the present disclosure. As illustrated in FIG. 7, the motion estimation unit 13 obtains a 3D/2D list. The 3D/2D list includes a three-dimensional position (x1, y1, z1) which is a target for resolving uncertainty. The candidate position calculation unit 12 obtains a modulation frequency for irradiation light from the iToF camera 20. The candidate position calculation unit 12 obtains candidate positions (x1, y1, z1), (x1′, y1′, z1′), and (x1″, y1″, z1″) on the basis of the modulation frequency for irradiation light and the three-dimensional position (x1, y1, z1).

The motion estimation unit 13 adds, to a 3D/2D list and as entries based on uncertainty in distance measurement by the iToF camera 20, entries in which these candidate positions (x1, y1, z1), (x1′, y1′, z1′), and (x1″, y1″, z1″) are each associated with a two-dimensional position (u1, v1) which is an observation position (S31). The motion estimation unit 13 randomly selects three entries from the 3D/2D list (S11). The motion estimation unit 13 generates a motion hypothesis on the basis of the three selected entries (S12). A motion hypothesis (t1, r1) is generated first.

The motion estimation unit 13 calculates a position for projecting a three-dimensional position included in the 3D/2D list with respect to the two-dimensional image corresponding to the motion hypothesis (S13). Firstly, a projection position for the three-dimensional position (x1, y1, z1), which is included in the 3D/2D list, with respect to the two-dimensional image corresponding to the motion hypothesis (t1, r1) is calculated. The motion estimation unit 13 calculates the distance between the two-dimensional position (observation position) corresponding to the three-dimensional position and the projection position, casts a vote indicating ∘ (a predetermined vote) for the motion hypothesis in a case where the distance is less than a threshold, and casts a vote indicating ● for the motion hypothesis in a case where the distance is greater than or equal to the threshold (S14 and S15).

Firstly, the distance between the two-dimensional position (u1, v1) (observation position) corresponding to the three-dimensional position (x1, y1, z1) and the projection position is calculated, it is determined that this distance is less than the threshold, and a vote indicating ∘ (a predetermined vote) is cast for the motion hypothesis (t1, r1). In a case where there is an entry for which voting has not ended (“NO” in S16), the operation is transitioned to S13. In contrast, in a case where voting has ended for all entries (“YES” in S16), the operation is transitioned to S17. In a case where voting from all entries included in the 3D/2D list has ended with respect to the motion hypothesis (t1, r1), the operation is transitioned to S17.

In a case where motion hypotheses for which voting has ended do not reach the upper limit (“NO” in S17), the operation is transitioned to S11. In contrast, in a case where voting has ended for the upper limit for motion hypotheses (“NO” in S17), the operation is transitioned to S18. Specifically, in a case where voting for the motion hypotheses (t1, r1) through (t100, r100) has ended, the operation is transitioned to S18.

From among the motion hypotheses (t1, r1) through (t100, r100), the motion estimation unit 13 employs the motion hypothesis having the greatest number of votes indicating ∘ (number of votes achieved) (S18). In the example illustrated in FIG. 5, the motion hypothesis (t2, r2) has the greatest number of votes achieved, and thus the motion hypothesis (t2, r2) is employed.

The motion estimation unit 13 determines an entry that has cast a vote indicating ● with respect to the motion hypothesis (t2, r2) selected in such a manner to be an outlier, and rejects the entry that has cast a vote indicating ● from the 3D/2D list. In contrast, the motion estimation unit 13 determines an entry that has cast a vote indicating ∘ with respect to the motion hypothesis (t2, r2) selected in such a manner to be an inlier, and keeps the entry that has cast a vote indicating ∘ in the 3D/2D list (S19). Further, the motion estimation unit 13 outputs the position and orientation (pose) of the iToF camera 20 to the pose observation usage unit 30. At this time, the motion estimation unit 13 may output the selected motion hypothesis (t2, r2) itself to the pose observation usage unit 30. Alternatively, the motion estimation unit 13 may output, to the pose observation usage unit 30, a pose obtained by re-estimating a motion hypothesis on the basis of entries determined to be inliers. As a result, it is possible for a more accurate pose to be outputted to the pose observation usage unit 30.

From among the candidate positions (x1, y1, z1), (x1′, y1′, z1′), and (x1″, y1″, z1″), the position determination unit 14 determines a candidate position that satisfies a determination condition to be a determined position. As a result, uncertainty in the three-dimensional position (x1, y1, z1) can be resolved (S32). The position determination unit 14 outputs a distance measurement result for which uncertainty has been reduced to the distance measurement observation usage unit 40.

Description has been given above regarding the first embodiment of the present disclosure.

### 2. Second Embodiment

Next, description is given regarding a second embodiment of the present disclosure.

(2.1. Functional Configuration Example)

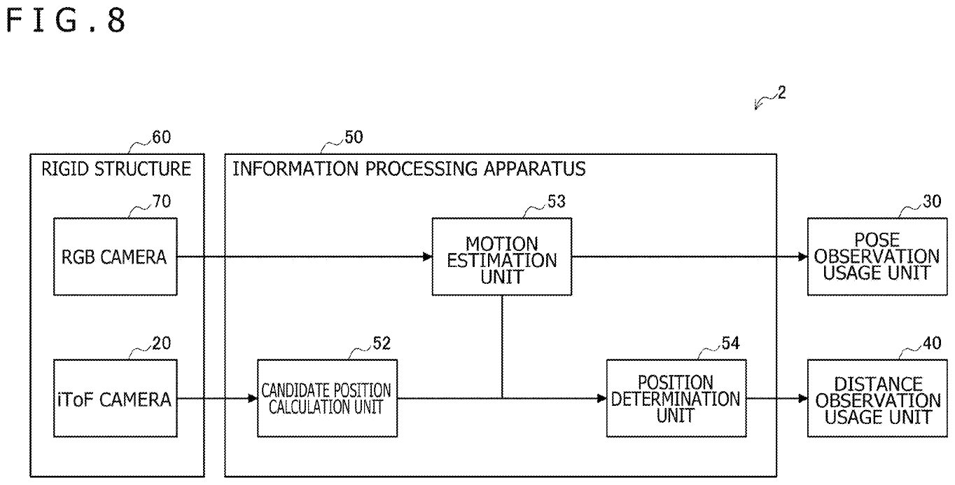

Firstly, description is given regarding an example of a functional configuration of an information processing system according to the second embodiment of the present disclosure. FIG. 8 is a view that illustrates an example of a functional configuration of the information processing system according to the second embodiment of the present disclosure. As illustrated in FIG. 8, an information processing system 2 according to a second embodiment of the present disclosure includes an information processing apparatus 50, a rigid structure 60, a pose observation usage unit 30, and a distance measurement observation usage unit 40. The rigid structure 60 includes an RGB camera 70 and an iToF camera 20. Note that, in place of the RGB camera 70, another camera (for example, a grayscale camera or the like) configured to be able to obtain its own position and orientation may be included in the rigid structure 60.

Here, the iToF camera 20, the pose observation usage unit 30, and the distance measurement observation usage unit 40 according to the second embodiment of the present disclosure have similar functions to the iToF camera 20, the pose observation usage unit 30, and the distance measurement observation usage unit 40 according to the first embodiment of the present disclosure. Accordingly, in the second embodiment of the present disclosure, detailed description of these is omitted, and description is mainly given regarding the RGB camera 70 and the information processing apparatus 50.

(RGB Camera 70)

The RGB camera 70 is configured to be able to obtain its own position and orientation. Here, the RGB camera 70 and the iToF camera 20 are included in the same rigid structure. Accordingly, the position and orientation of the RGB camera 70 is in a fixed constant relation with respect to the position and orientation of the iToF camera 20. In other words, the position and orientation of the RGB camera 70 and the position and orientation of the iToF camera 20 are in a relation that enables one position and orientation to be easily calculated from the other position and orientation. As an example, the RGB camera 70 may output its own position and orientation to the information processing apparatus 50. At this point, the information processing apparatus 50 may calculate the position and orientation of the iToF camera 20 on the basis of the position and orientation of the RGB camera 70. Alternatively, the position and orientation of the iToF camera 20 calculated on the basis of the position and orientation of the RGB camera 70 by the rigid structure 60 may be outputted to the information processing apparatus 50.

A case in which the RGB camera 70 outputs the position and orientation of the iToF camera 20 (first position and orientation information) at a time 1 (a first time) to the information processing apparatus 50 is mainly assumed here. A case in which the RGB camera 70 outputs the position and orientation of the iToF camera 20 (second position and orientation information) at a time 0 (a second time) different from the time 1 (the first time) to the information processing apparatus 50 is also mainly assumed here. Here, a case in which the time 0 (the second time) is earlier than the time 1 (the first time) is assumed.

(Information Processing Apparatus 50)

The information processing apparatus 50 includes a candidate position calculation unit 52, a motion estimation unit 53 (position and orientation obtainment unit), and a position determination unit 54. Note that description is given later regarding detailed functions for each of the candidate position calculation unit 52, the motion estimation unit 53, and the position determination unit 54.

The information processing apparatus 50, for example, may include one or more CPUs (Central Processing Unit; central processing unit). In a case where the information processing apparatus 50 includes a processor such as a CPU, this processor may include an electronic circuit. For the information processing apparatus 50, it is possible to use this processor to (realize execution of a program for causing a computer to function as the information processing apparatus 50.

In addition, the information processing apparatus 50 includes a memory which is not illustrated. The unillustrated memory is a recording medium that stores a program that is executed by the information processing apparatus 50 and stores data necessary for execution of this program. In addition, the unillustrated memory temporarily stores data for calculation by the information processing apparatus 50. The unillustrated memory includes a magnetic storage device, a semiconductor storage device, an optical storage device, a magneto-optical storage device, or the like.

From the RGB camera 70, the motion estimation unit 53 obtains the position and orientation (pose) of the iToF camera 20 at the time 1 (the first time) and also obtains the position and orientation of the iToF camera 20 at the time 0 (the second time). The motion estimation unit 53 outputs the position and orientation of the iToF camera 20 at each time to the pose observation usage unit 30. Note that a case in which the motion estimation unit 53 obtains the position and orientation of the iToF camera 20 from the outside is mainly assumed here. However, a technique by which the motion estimation unit 53 obtains the position and orientation of the iToF camera 20 is not limited to this example.

For example, the motion estimation unit 53 may use a combination of SLAM and a distance measurement result by the iToF camera 20 to estimate the position and orientation of the iToF camera 20, similarly to the motion estimation unit 13 according to the first embodiment of the present disclosure, or may use SLAM to estimate the position and orientation of the iToF camera 20 in accordance with another technique. Alternatively, the motion estimation unit 53 may estimate the position and orientation of the iToF camera 20 using a technique other than SLAM.

The candidate position calculation unit 52 obtains a distance measurement result (two-dimensional image) that is obtained at the time 1 (the first time) by the iToF camera 20. In addition, the candidate position calculation unit 52 obtains a three-dimensional position (first measurement data) for a certain point from the distance measurement result obtained at the time 1 (the first time). The candidate position calculation unit 52 obtains multiple candidate positions at the time 1 (the first time) on the basis of the three-dimensional position for this point. A technique of obtaining multiple candidate positions according to the second embodiment of the present disclosure is similar to the technique for obtaining multiple candidate positions according to the first embodiment of the present disclosure. In addition, the candidate position calculation unit 52 obtains a distance measurement result (second measurement data) that is obtained at the time 0 (the second time) by the iToF camera 20.

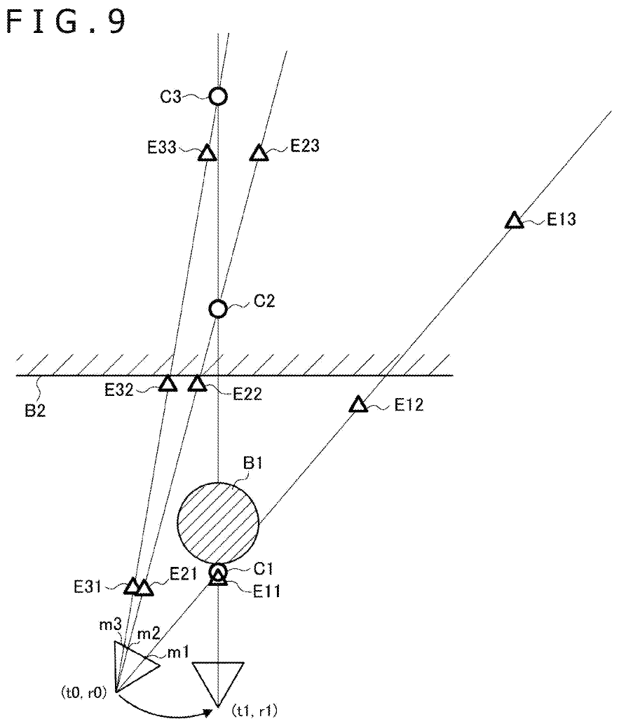

The position determination unit 54 determines one candidate position from among the multiple candidate positions to be a determined position, on the basis of the multiple candidate positions for the time 1 (the first time), the position and orientation of the iToF camera 20 at the time 1 (the first time) that are obtained by the motion estimation unit 53, the distance measurement result obtained at the time 0 (the second time), and the position and orientation of the iToF camera 20 at the time 0 (the second time) that are obtained by the motion estimation unit 53. With reference to FIG. 9, description is given below regarding a technique for determining a position, according to the second embodiment of the present disclosure.

FIG. 9 is a view for giving a description regarding a technique for determining a position, according to the second embodiment of the present disclosure. Referring to FIG. 9, the position (a translational component) and the orientation (a rotational component) of the iToF camera 20 at the time 0 (the second time) are indicated as (t0, r0). In addition, the position (a translational component) and the orientation (a rotational component) of the iToF camera 20 at the time 1 (the first time) are indicated as (t1, r1). In addition, referring to FIG. 9, an object B1 and an object B2 are present in real space. The object B1 is a column and the object B2 is a wall, but the object type is not limited to any type.

In a case where the pose of the iToF camera 20 is (t1, r1), a three-dimensional position C1 for a point on the surface of the object B1 is obtained as a distance measurement result. In contrast, in a case where the pose of the iToF camera 20 is (t0, r0), a three-dimensional position E11 for a point on the surface of the object B1 is obtained as a distance measurement result. In addition, in the case where the pose of the iToF camera 20 is (t0, r0), three-dimensional positions E31 and E21, which are in front of three-dimensional positions E22 and E32 for points on the surface of the object B2, are obtained as distance measurement results.

The candidate position calculation unit 52 obtains the three-dimensional position C1 as one candidate position (a first candidate position) and, on the basis of this three-dimensional position C1, obtains a three-dimensional position C2 and a three-dimensional position C3 as other candidate positions (first candidate positions). In other words, the candidate position calculation unit 52 obtains candidate positions C1 through C3 (first candidate positions).

For the candidate position C1, the position determination unit 54 calculates a projection position m1 with respect to the two-dimensional image corresponding to the pose (t0, r0) of the iToF camera 20. The position determination unit 54 obtains a distance measurement result E11 for the projection position m1 for the iToF camera 20 at the time for the pose (t0, r0). On the basis of the distance measurement result E11, the candidate position calculation unit 52 uses a similar technique to obtain candidate positions E11 through E13 (second candidate positions).

For the candidate position C2, the position determination unit 54 calculates a projection position m2 with respect to the two-dimensional image corresponding to the pose (t0, r0) of the iToF camera 20. The position determination unit 54 obtains a distance measurement result E21 for the projection position m2 for the iToF camera 20 at the time for the pose (t0, r0). On the basis of the distance measurement result E21, the candidate position calculation unit 52 uses a similar technique to obtain candidate positions E21 through E23 (second candidate positions).

For the candidate position C3, the position determination unit 54 calculates a projection position m3 with respect to the two-dimensional image corresponding to the pose (t0, r0) of the iToF camera 20. The position determination unit 54 obtains a distance measurement result E31 for the projection position m3 for the iToF camera 20 at the time for the pose (t0, r0). On the basis of the distance measurement result E31, the candidate position calculation unit 52 uses a similar technique to obtain candidate positions E31 through E33 (second candidate positions).

On the basis of the candidate positions C1 through C3 and the candidate positions E11 through E13, E21 through E23, and E31 through E33, the position determination unit 54 determines one candidate position from the candidate positions C1 through C3 to be a determined position. In more detail, the position determination unit 54 calculates the distance between the candidate position C1 and each of the candidate positions E11 through E13, calculates the distance between the candidate position C2 and each of the candidate positions E21 through E23, and calculates the distance between the candidate position C3 and each of the candidate positions E31 through E33. On the basis of these distances, the position determination unit 54 determines one of the candidate positions C1 through C3 to be the determined position.

In further detail, the position determination unit 54 is only required to determine, from among the candidate positions C1 through C3, a candidate position having the shortest calculated distance to be the determined position. In the example illustrated in FIG. 9, the candidate position E11 has the shortest distance to the candidate position C1, the candidate position E22 has the shortest distance to the candidate position C2, and the candidate position E33 has the shortest distance to the candidate position C3. The distance between the candidate position C1 and the candidate position E11 is the shortest from among these. Accordingly, the position determination unit 54 is only required to determine the candidate position C1, for which the calculated distance is the shortest, to be the determined position. As a result, uncertainty in the three-dimensional position C1 can be resolved.

The position determination unit 54 outputs a distance measurement result for which uncertainty has been reduced to the distance measurement observation usage unit 40. In more detail, the position determination unit 54 finalizes a distance measurement result for the projection position m1 that corresponds to the three-dimensional position C1 set as a target for resolving uncertainty and is from a two-dimensional image obtained by the iToF camera 20 to a distance corresponding to the determined position C1, and then outputs a finalized two-dimensional image to the distance measurement observation usage unit 40. Note that the distance corresponding to the determined position C1 is the length for (x1, y1, z1) itself, and there is no particular need to change the distance measurement result for the projection position m1.

Note that, when there is coverage for all respective combinations of candidate positions which have uncertainty, a calculation amount becomes enormous.

Accordingly, the calculation amount can be reduced by dividing space into multiple voxels and combining distance measurement by the iToF camera 20 with an occupancy map technique to have votes cast in a voxel grid.

(2.2. Example of Operation)

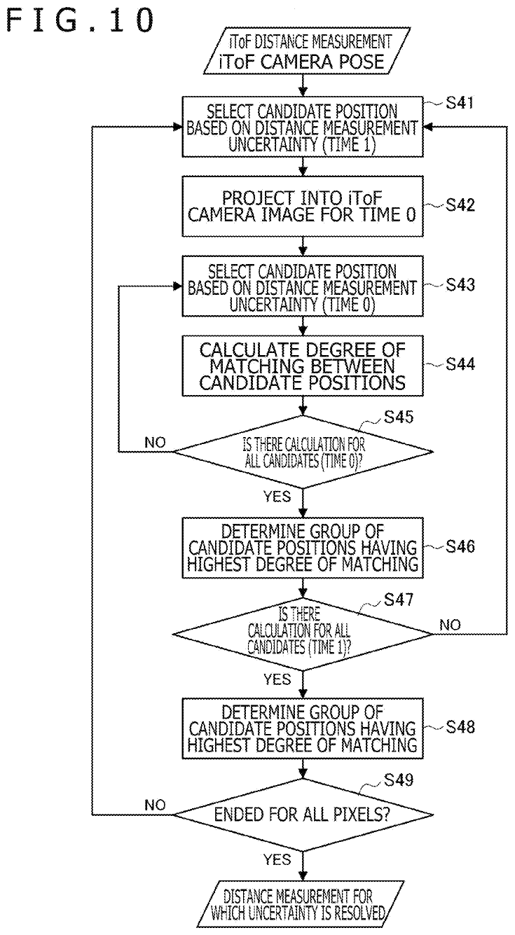

Next, description is given regarding an example of operation by the information processing system 2 according to the second embodiment of the present disclosure. FIG. 10 is a view that illustrates an example of operation by the information processing system 2 according to the second embodiment of the present disclosure. As illustrated in FIG. 10, in the information processing system 2 according to the second embodiment of the present disclosure, the candidate position calculation unit 52 obtains a distance measurement result (a two-dimensional image) by the iToF camera 20, and the motion estimation unit 53 obtains a pose of the iToF camera 20.

The candidate position calculation unit 52 obtains multiple candidate positions based on distance measurement uncertainty in the pose (t1, r1) (in other words, at the time 1) of the iToF camera 20. The position determination unit 54 selects one candidate position from multiple candidate positions C1 through C3 (S41). Firstly, the candidate position C1 is selected. For the selected candidate position, the position determination unit 54 calculates a projection position with respect to the two-dimensional image corresponding to the pose (t0, r0) of the iToF camera 20 (S42). Firstly, the projection position m1 is calculated.

The candidate position calculation unit 52 obtains multiple candidate positions corresponding to the pose (t0, r0) of the iToF camera 20 at the projection position (in other words, corresponding to the time 0). Firstly, the candidate positions E11 through E13 corresponding to the pose (t0, r0) of the iToF camera 20 at the projection position m1 are obtained. The position determination unit 54 selects one candidate position from the multiple candidate positions (S43). Firstly, the candidate position E11 is selected.

The position determination unit 54 calculates a degree of matching (in other words, a distance) between selected candidate positions (S44). Firstly, the degree of matching between the candidate position C1 and the candidate position E11 is calculated. In a case where calculation of the degree of matching has not ended for all candidate positions corresponding to the pose (t0, r0) of the iToF camera 20 (in other words, corresponding to the time 0) (“NO” in S45), the operation is transitioned to S43. In contrast, for the position determination unit 54 in a case where calculation of the degree of matching has ended for all candidate positions corresponding to the pose (t0, r0) of the iToF camera 20 (“YES” in S45), the operation is transitioned to S46.

Specifically, when calculation of the degree of matching between the candidate position C1 and the candidate position E11 has ended, calculation of the degree of matching between the candidate position C1 and the candidate position E12 has ended, and calculation of the degree of matching between the candidate position C1 and the candidate position E13 has ended, the operation is transitioned to S46. Next, the position determination unit 54 determines a group of candidate positions having the highest degree of matching (in other words, a group of candidate positions having the shortest distance) (S46). Firstly, the group of the candidate position C1 and the candidate position E11 is determined to be a group having the highest degree of matching.

In a case where calculation of the degree of matching has not ended for all candidate positions for the pose (t1, r1) of the iToF camera 20 (in other words, corresponding to the time 1) (“NO” in S47), the operation is transitioned to S41. In contrast, for the position determination unit 54 in a case where calculation of the degree of matching has ended for all candidate positions corresponding to the pose (t1, r1) of the iToF camera 20 (“YES” in S47), the operation is transitioned to S48.

Specifically, when the group of the candidate position C2 and the candidate position E22 is determined to be a group having the highest degree of matching and the group of the candidate position C3 and the candidate position E33 is determined to be a group having the highest degree of matching, operation is transitioned to S48. The position determination unit 54 determines a group of candidate positions having the highest degree of matching (in other words, a group of candidate positions having the shortest distance) (S46).

Specifically, from among the group of the candidate position C1 and the candidate position E11, the group of the candidate position C2 and the candidate position E22, and the group of the candidate position C3 and the candidate position E33, the group of the candidate position C1 and the candidate position E11 is determined to be the group of candidate positions having the highest degree of matching.

In a case where processing has not ended for all pixels in the two-dimensional image (“NO” in S49), the operation for S41 and thereafter is re-executed for the next pixel. In contrast, in a case where processing has ended for all pixels in the two-dimensional image (“YES” in S49), a distance measurement result for which uncertainty has been resolved is outputted to the distance measurement observation usage unit 40.

Description has been given above regarding an example of operation by the information processing system 2 according to the second embodiment of the present disclosure.

<3. Hardware Configuration Example>

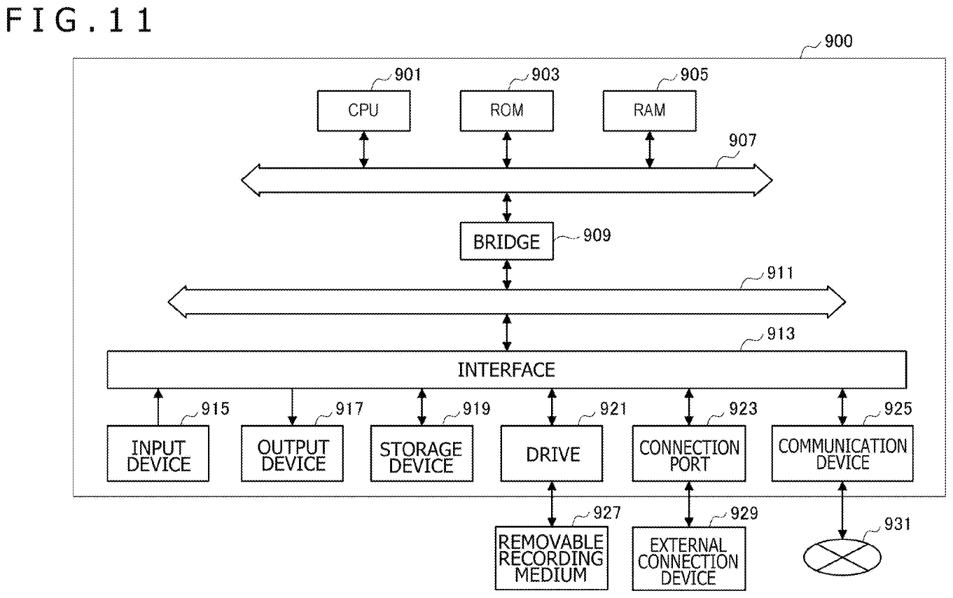

Next, with reference to FIG. 11, description is given regarding an example of a hardware configuration of an information processing apparatus 900 which serves as an example of the information processing apparatus 10 according to the first embodiment of the present disclosure and the information processing apparatus 50 according to the second embodiment of the present disclosure. FIG. 11 is a block diagram that illustrates an example of a hardware configuration for an information processing apparatus 900. Note that the information processing apparatus 10 and the information processing apparatus 50 do not necessarily need to have all of the hardware configuration illustrated in FIG. 11, and a portion of the hardware configuration illustrated in FIG. 11 may not be present in the information processing apparatus 10 and the information processing apparatus 50.

As illustrated in FIG. 11, the information processing apparatus 900 includes a CPU (Central Processing Unit) 901, a ROM (Read-Only Memory) 903, and a RAM (Random-Access Memory) 905. In addition, the information processing apparatus 900 may include a host bus 907, a bridge 909, an external bus 911, an interface 913, an input device 915, an output device 917, a storage device 919, a drive 921, a connection port 923, and a communication device 925. In place of or in addition to the CPU 901, the information processing apparatus 900 may have a processing circuit such as that referred to as a DSP (Digital Signal Processor) or an ASIC (Application-Specific Integrated Circuit).

The CPU 901 functions as an arithmetic processing apparatus and a control apparatus, and controls the entirety or a portion of operation within the information processing apparatus 900 in accordance with various computer programs that are recorded in the ROM 903, the RAM 905, the storage device 919, or a removable recording medium 927. The ROM 903 stores arithmetic parameters and programs used by the CPU 901. The RAM 905 temporarily stores a program used in execution by the CPU 901, a parameter that changes as appropriate in this execution, or the like. The CPU 901, the ROM 903, and the RAM 905 are mutually connected by the host bus 907, which includes an internal bus such as a CPU bus. Further, the host bus 907 is connected to the external bus 911, which is a PCI (Peripheral Component Interconnect/Interface) bus or the like, via the bridge 909.

The input device 915 is an apparatus that is operated by a user using a button or the like, for example. The input device 915 may include a mouse, a keyboard, a touch panel, a switch, a lever, and the like. In addition, the input device 915 may include a microphone for detecting audio from a user. For example, the input device 915 may be a remote-control apparatus that uses infrared rays or other radio waves, or may be an external connection device 929 such as a mobile phone that supports operation by the information processing apparatus 900. The input device 915 includes an input control circuit that generates an input signal on the basis of information inputted by the user and outputs the input signal to the CPU 901. By operating the input device 915, the user can input various pieces of data to the information processing apparatus 900 and instruct a processing operation. In addition, a later-described image capturing apparatus 933 can capture an image of motion by a user's hand or a user's finger to thereby function as an input device. At this time, a pointing position in accordance with motion by the hand or the orientation of the finger may be determined.

The output device 917 includes an apparatus that can visually or auditorily notify the user of obtained information. For example, the output device 917 can be a display apparatus such as an LCD (Liquid Crystal Display) or an organic EL (Electro-Luminescence) display, or a sound output device such as a speaker or headphones. In addition, the output device 917 may include a PDP (Plasma Display Panel), a projector, a hologram, a printer apparatus, or the like. The output device 917 outputs a result obtained by processing in the information processing apparatus 900 as a video having text, images, or the like, or outputs the result as sound such as speech or audio. In addition, the output device 917 may include a light or the like for brightening the vicinity.

The storage device 919 is an apparatus which is for data storage and which is formed as an example of a storage unit in the information processing apparatus 900. For example, the storage device 919 includes a magnetic storage device such as an HDD (Hard Disk Drive), a semiconductor storage device, an optical storage device, or a magneto-optical storage device. The storage device 919 stores a program that the CPU 901 executes, various pieces of data, various pieces of data obtained from an external unit, and the like.

The drive 921 is a reader/writer for a removable recording medium 927 which is a magnetic disk, an optical disk, a magneto-optical disk, or a semiconductor memory, and the drive 921 is incorporated in or externally attached to the information processing apparatus 900. The drive 921 reads out information recorded to the removable recording medium 927 which is mounted, and outputs the information to the RAM 905. In addition, the drive 921 writes a record to the mounted removable recording medium 927.

The connection port 923 is a port for directly connecting a device to the information processing apparatus 900. For example, the connection port 923 can be a USB (Universal Serial Bus) port, an IEEE 1394 port, a SCSI (Small Computer System Interface) port, or the like. In addition, the connection port 923 may be an RS-232C port, an optical audio terminal, an HDMI (registered trademark) (High-Definition Multimedia Interface) port, or the like. By connecting the external connection device 929 to the connection port 923, various items of data can be exchanged between the information processing apparatus 900 and the external connection device 929.

The communication device 925, for example, is a communication interface including a communication device for connecting to the network 931. The communication device 925 is, for example, a communication card for a wired or wireless LAN (Local Area Network), Bluetooth (registered trademark), or WUSB (Wireless USB). In addition, the communication device 925 may be a router for optical communication, a router for ADSL (Asymmetric Digital Subscriber Line), a modem for various types of communication, or the like. For example, the communication device 925 uses a predetermined protocol such as TCP/IP to transmit and receive a signal to and from the Internet or another communication device. In addition, the network 931 connected to the communication device 925 is connected by wire or wirelessly, and is the Internet, a home LAN, infrared communication, radio wave communication, or satellite communication, for example.

### 4. Summary

By virtue of the embodiments of the present disclosure, improvements are expected for the availability of SLAM, which takes a distance measurement result obtained using an iToF camera as an input. As an example, it is expected that constraints imposed on an operating environment for an iToF camera will be relaxed. For example, a constraint imposed on the operating environment for an iToF camera is that an object to be subject to distance measurement by the iToF camera must be present within a certain distance from the iToF camera.

In addition, it is expected that the success rate of pose estimation using SLAM, which takes a distance measurement result using an iToF camera as an input, will rise, and the accuracy of the pose estimation will improve. Furthermore, it is expected that the robustness of pose estimation for an iToF camera that moves at high speed will improve (in comparison to Dual-modulation iToF described in NPL 1 above, or the like).

In addition, by virtue of embodiments according to the present disclosure, improving accuracy for distance measurement using an iToF camera is expected. For example, uncertainty in distance measurement using an iToF camera is resolved, whereby enlarging a distance measurement range using the iToF camera is expected. Furthermore, it is expected that the robustness of distance measurement by an iToF camera that moves at high speed will improve (in comparison to Dual-modulation iToF described in NPL 1 above, or the like).

Description in detail has been given above regarding preferred embodiments of the present disclosure with reference to the attached drawings, but the technical scope of the present disclosure is not limited to the corresponding examples. It is obvious that various modifications or revisions within the category of the technical concept set forth in the claims can be conceived of by a person having ordinary knowledge in the technical field of the present disclosure, and it is understood that these modifications or revisions naturally belong to the technical scope of the present disclosure.

In addition, effects described in the present specification are purely descriptive or illustrative, and are not limited. In other words, in addition to or in place of the effects described above, a feature according to the present disclosure can achieve other effects that are clear to a person skilled in the art from the description of the present specification.

The first embodiment of the present disclosure and the second embodiment of the present disclosure are separately described above. However, the first embodiment of the present disclosure and the second embodiment of the present disclosure may be combined, as appropriate. In more detail, resolving uncertainty in a distance measurement result by the information processing apparatus 10 according to the first embodiment of the present disclosure and resolving uncertainty in a distance measurement result by the information processing apparatus 50 according to the second embodiment of the present disclosure may be executed in combination.

Note that configurations such as the following also belong to the technical scope of the present disclosure.

(1)

An information processing apparatus including:
a candidate position calculation unit configured to obtain multiple candidate positions on the basis of first measurement data that is for a three-dimensional position and is obtained by a sensor; and
a determination unit configured to, on a basis of the candidate positions and second measurement data that is for a three-dimensional position and is obtained by the sensor, determine any one of the candidate positions to be a determined position.
   (2)

The information processing apparatus according to (1), in which
the determination unit includes
   a position and orientation estimation unit configured to, on the basis of the candidate positions and the second measurement data, estimate a position and orientation of the sensor and obtain position and orientation estimation information, and
   a position determination unit configured to, on a basis of the position and orientation estimation information, determine the determined position from the candidate positions.
      (3)

The information processing apparatus according to (2), in which
the second measurement data includes one or multiple measurement positions, and
the position and orientation estimation unit performs a selection process for selecting a predetermined number of positions from the candidate positions and the measurement positions, and generates the position and orientation estimation information on a basis of the predetermined number of positions.
   (4)

The information processing apparatus according to (3), in which
the position and orientation estimation unit, by executing the selection process and a generation process for generating position and orientation generation information on the basis of the predetermined number of positions multiple times, generates multiple items of position and orientation generation information, and selects the position and orientation estimation information from the multiple items of position and orientation generation information.
   (5)

The information processing apparatus according to (3) or (4), in which
the position and orientation estimation unit does not select two or more of the candidate positions as the predetermined number of positions in each selection process.
   (6)

The information processing apparatus according to (4) or (5), in which,
for each item of the position and orientation generation information, the position and orientation estimation unit calculates a distance between, for each of the candidate position and the measurement position, an observation position that appears in a two-dimensional image obtained by the sensor and a projection position with respect to a two-dimensional image corresponding to the position and orientation generation information, and selects the position and orientation estimation information on a basis of the distance between the observation position and the projection position for each item of the position and orientation generation information.
   (7)

The information processing apparatus according to (6), in which
the position and orientation estimation unit casts predetermined votes for position and orientation generation information for which the distance between the observation position and the projection position is less than a threshold and selects, as the position and orientation estimation information, the position and orientation generation information having the greatest number of the predetermined votes.
   (8)

The information processing apparatus according to (7), in which
the position determination unit determines a candidate position satisfying a predetermined condition from among the multiple candidate positions to be the determined position.
   (9)

The information processing apparatus according to (8), in which
the predetermined condition includes a first condition of being included in the predetermined number of positions used to generate the position and orientation estimation information.
   (10)

The information processing apparatus according to (8) or (9), in which
the predetermined condition includes a second condition of having cast the predetermined votes for the position and orientation estimation information.
   (11)

The information processing apparatus according to any one of (8) to (10), in which
the predetermined condition includes a third condition of having a shortest distance between the observation position and the projection position in the position and orientation estimation information.
   (12)

The information processing apparatus according to any one of (2) to (11), in which
the determined position is used to re-estimate a position and orientation of the sensor.
   (13)

The information processing apparatus according to (1), in which
the determination unit includes
   a position and orientation obtainment unit configured to obtain, as first position and orientation information, a position and orientation of the sensor at a first time and obtain, as second position and orientation information, a position and orientation of the sensor at a second time different from the first time, and
   a position determination unit configured to determine the determined position from the candidate positions on a basis of the candidate positions, the first position and orientation information, the second measurement data obtained at the second time, and the second position and orientation information, the candidate positions being obtained on a basis of the first measurement data obtained at the first time.
      (14)

The information processing apparatus according to (13), in which
the candidate positions include multiple first candidate positions, and
the position determination unit calculates a projection position with respect to a two-dimensional image corresponding to the second position and orientation information for a corresponding one of the first candidate positions, and determines the determined position on a basis of the first candidate position and multiple second candidate positions that are based on the second measurement data at the projection position and are obtained by the candidate position calculation unit.
   (15)

The information processing apparatus according to (14), in which
the position determination unit, for each of the first candidate positions, calculates a distance between the first candidate position and each of the multiple second candidate positions, and determines the determined position on a basis of the distance.
   (16)

The information processing apparatus according to (15), in which
the position determination unit determines the first candidate position for which the distance is shortest to be the determined position.
   (17)

The information processing apparatus according to any one of (1) to (16), in which
the sensor measures a three-dimensional position on an object surface on a basis of a phase shift between irradiation light and light reflected on the object surface by the irradiation light.
   (18)

The information processing apparatus according to (17), in which
the candidate position calculation unit obtains the multiple candidate positions on a basis of a modulation frequency for the irradiation light and the first measurement data.
   (19)

An information processing method including:
by a processor, obtaining multiple candidate positions on the basis of first measurement data that is for a three-dimensional position and is obtained by a sensor; and
determining, on a basis of the candidate positions and second measurement data that is for a three-dimensional position and is obtained by the sensor, that any one of the candidate positions to be a determined position.
   (20)

A program for causing a computer to function as an information processing apparatus including:
a candidate position calculation unit configured to obtain multiple candidate positions on the basis of first measurement data that is for a three-dimensional position and is obtained by a sensor; and
a determination unit configured to, on a basis of the candidate positions and second measurement data that is for a three-dimensional position and is obtained by the sensor, determine any one of the candidate positions to be a determined position.

### REFERENCE SIGNS LIST

1, 2: Information processing system
10, 50: Information processing apparatus
12: Candidate position calculation unit
13: Motion estimation unit
14: Position determination unit
20: iToF camera
30: Pose observation usage unit
40: Distance measurement observation usage unit
52: Candidate position calculation unit
53: Motion estimation unit
54: Position determination unit
60: Rigid structure
70: RGB camera

1. An information processing apparatus comprising:
a candidate position calculation unit configured to obtain multiple candidate positions on a basis of first measurement data that is for a three-dimensional position and is obtained by a sensor; and
a determination unit configured to, on a basis of the candidate positions and second measurement data that is for a three-dimensional position and is obtained by the sensor, determine any one of the candidate positions to be a determined position.

2. The information processing apparatus according to claim 1, wherein
the determination unit includes
a position and orientation estimation unit configured to, on the basis of the candidate positions and the second measurement data, estimate a position and orientation of the sensor and obtain position and orientation estimation information, and
a position determination unit configured to, on a basis of the position and orientation estimation information, determine the determined position from the candidate positions.

3. The information processing apparatus according to claim 2, wherein
the second measurement data includes one or multiple measurement positions, and
the position and orientation estimation unit performs a selection process for selecting a predetermined number of positions from the candidate positions and the measurement positions, and generates the position and orientation estimation information on a basis of the predetermined number of positions.

4. The information processing apparatus according to claim 3, wherein
the position and orientation estimation unit, by executing the selection process and a generation process for generating position and orientation generation information on the basis of the predetermined number of positions multiple times, generates multiple items of position and orientation generation information, and selects the position and orientation estimation information from the multiple items of position and orientation generation information.

5. The information processing apparatus according to claim 3, wherein
the position and orientation estimation unit does not select two or more of the candidate positions as the predetermined number of positions in each selection process.

6. The information processing apparatus according to claim 4, wherein,
for each item of the position and orientation generation information, the position and orientation estimation unit calculates a distance between, for each of the candidate position and the measurement position, an observation position that appears in a two-dimensional image obtained by the sensor and a projection position with respect to a two-dimensional image corresponding to the position and orientation generation information, and selects the position and orientation estimation information on a basis of the distance between the observation position and the projection position for each item of the position and orientation generation information.

7. The information processing apparatus according to claim 6, wherein
the position and orientation estimation unit casts predetermined votes for position and orientation generation information for which the distance between the observation position and the projection position is less than a threshold and selects, as the position and orientation estimation information, the position and orientation generation information having the greatest number of the predetermined votes.

8. The information processing apparatus according to claim 7, wherein
the position determination unit determines a candidate position satisfying a predetermined condition from among the multiple candidate positions to be the determined position.

9. The information processing apparatus according to claim 8, wherein
the predetermined condition includes a first condition of being included in the predetermined number of positions used to generate the position and orientation estimation information.

10. The information processing apparatus according to claim 8, wherein
the predetermined condition includes a second condition of having cast the predetermined votes for the position and orientation estimation information.

11. The information processing apparatus according to claim 8, wherein
the predetermined condition includes a third condition of having a shortest distance between the observation position and the projection position in the position and orientation estimation information.

12. The information processing apparatus according to claim 2, wherein
the determined position is used to re-estimate a position and orientation of the sensor.

13. The information processing apparatus according to claim 1, wherein
the determination unit includes
a position and orientation obtainment unit configured to obtain, as first position and orientation information, a position and orientation of the sensor at a first time and obtain, as second position and orientation information, a position and orientation of the sensor at a second time different from the first time, and
a position determination unit configured to determine the determined position from the candidate positions on a basis of the candidate positions, the first position and orientation information, the second measurement data obtained at the second time, and the second position and orientation information, the candidate positions being obtained on a basis of the first measurement data obtained at the first time.

14. The information processing apparatus according to claim 13, wherein
the candidate positions include multiple first candidate positions, and
the position determination unit calculates a projection position with respect to a two-dimensional image corresponding to the second position and orientation information for a corresponding one of the first candidate positions, and determines the determined position on a basis of the first candidate position and multiple second candidate positions that are based on the second measurement data at the projection position and are obtained by the candidate position calculation unit.

15. The information processing apparatus according to claim 14, wherein
the position determination unit, for each of the first candidate positions, calculates a distance between the first candidate position and each of the multiple second candidate positions, and determines the determined position on a basis of the distance.

16. The information processing apparatus according to claim 15, wherein
the position determination unit determines the first candidate position for which the distance is shortest to be the determined position.

17. The information processing apparatus according to claim 1, wherein
the sensor measures a three-dimensional position on an object surface on a basis of a phase shift between irradiation light and light reflected on the object surface by the irradiation light.

18. The information processing apparatus according to claim 17, wherein
the candidate position calculation unit obtains the multiple candidate positions on a basis of a modulation frequency for the irradiation light and the first measurement data.

19. An information processing method comprising:
by a processor, obtaining multiple candidate positions on a basis of first measurement data that is for a three-dimensional position and is obtained by a sensor; and
determining, on a basis of the candidate positions and second measurement data that is for a three-dimensional position and is obtained by the sensor, that any one of the candidate positions to be a determined position.

20. A program for causing a computer to function as an information processing apparatus including:
a candidate position calculation unit configured to obtain multiple candidate positions on a basis of first measurement data that is for a three-dimensional position and is obtained by a sensor; and
a determination unit configured to, on a basis of the candidate positions and second measurement data that is for a three-dimensional position and is obtained by the sensor, determine any one of the candidate positions to be a determined position.
